(19) United States
(12) Patent Application Publication
(10) Pub. No.: US 2007/0254990 A1
(43) Pub. Date: Nov. 1, 2007

(54) Pipe coating composition

(75) Inventors: Ronald W. Lewoniuk, Calgary (CA); Ian Robert Gibbons, Calgary (CA)

Correspondence Address: Kenneth H. Johnson;Patent Attorney, P.O. Box 630708, Houston, TX, 77263, US

(73) Assignee: NOVA CHEMICALS (INTERNATIONAL) S.A.

(21) Appl. No.: 11/786,114

(22) Filed: Apr. 11, 2007

(30) Foreign Application Priority Data
Apr. 26, 2006 (CA) 2,544,891

(51) Int. Cl. C08K 5/49

(52) U.S. Cl. 524/115; 524/323

(57) ABSTRACT

A pipe coating composition comprises a linear polyethylene having a specific melt index and a narrow molecular weight distribution and an additive package comprising a hindered phenolic, a phosphite and a hindered amine light stabilizer. The composition preferably contains carbon black. The composition permits high rates of application and provides good oxidative induction times.

### FIELD OF THE INVENTION

This invention relates to a polyethylene composition which is used to “melt coat” metal pipe. The coating composition is designed to reduce damage to the pipe, which might be caused by exposure to the elements, corrosion, or mechanical damage.

### BACKGROUND OF THE INVENTION

The use of polyethylene melt coat on pipe is well known. The polyethylene may be applied directly to the pipe surface or alternatively to a ‘primer’ surface (such as a layer of epoxy resin which is initially applied to the pipe surface). This melt coating procedure has certain advantages over other coating options such as solvent-based coats (e.g. eliminating the need for the solvent and mitigating environmental concerns) and tape coating (e.g. improved adhesion of melt coat versus tape).

However, care must be taken when melt coating in order to ensure a complete and uniform coat of the material which is being applied. In addition, the resulting coating must provide a durable finish, which can withstand exposure to the environment and some mechanical abuse.

The selection of an appropriate polymer architecture is required to meet these objectives. As described in U.S. Pat. No. 6,645,588 (Leiden et al.; the disclosure of which is incorporated herein by reference), the use of a polyethylene composition having a broad molecular weight distribution (to the point where the composition has a bimodal/polymodal molecular weight distribution) has been proposed.

We have now discovered a desirable pipe coating composition, which is characterized by having a very narrow molecular weight distribution, (i.e. the opposite of the composition taught by Leiden et al.). The present composition preferably has a comparatively sharp melting point, which permits easy application of the coating. The composition is further characterized by requiring an additive package comprising a hindered phenolic, a phosphite (or phosphonite) and a hindered amine light stabilizer.

### SUMMARY OF THE INVENTION

The present invention provides:

A pipe coating resin composition having an oxidation induction time in excess of five minutes, wherein said composition comprises:
i) a thermoplastic ethylene-alpha olefin copolymer composition having a melt index, I₂, of from 1 to 10 grams/10 minutes and a molecular weight distribution, Mw/Mn, of from 2.0 to 3.0; and
ii) an antioxidant system comprising a hindered phenolic, a secondary antioxidant which is a phosphorus (III) compound and a hindered amine light stabilizer.

Another embodiment of this invention provides a process for coating a pipe, said process comprising the application to said pipe of a pipe coating resin composition having an oxidative induction time in excess of five minutes, wherein, said composition comprises:
i) a thermoplastic ethylene-alpha olefin copolymer composition having a melt index, I₂, as determined by ASTM D1238 of from 1 to 10 grams/10 minutes and a molecular weight distribution of from 2.0 to 3.0; and
ii) an antioxidant system comprising from 250 to 2500 ppm of a hindered phenolic, a secondary antioxidant which is a phosphorus (III) compound and a hindered amine light stabilizer.

The compositions of this invention are prepared from a “homogenous” polyethylene resin, which facilitates the melt coating process. The use of a phenolic antioxidant has been found to provide good oxidative induction times (OIT) in this resin composition.

The compositions of this invention must contain a hindered phenolic antioxidant (described in detail under the heading Antioxidants, at sections 1.1 to 1.4, below), a hindered amine light stabilizer or HALS (section 2.6, below) and a phosphorus (III) secondary antioxidant. The term “phosphorus (III) secondary antioxidant” generally refers to all of the well known phosphites and phosphonites which are in wide spread commercial use (see section 4, below) as well as the phosphine compounds which have recently been proposed for use as secondary antioxidants.

While not wishing to bound by theory, it is generally believed that all of these secondary antioxidants operate via the same generalized mechanism, namely that they decompose peroxides by accepting oxygen (and in the process are oxidized from phosphorus (III) to phosphorus (IV).

### DETAILED DESCRIPTION OF PREFERRED EMBODIMENTS

As noted above, the polyethylene composites used in this invention must have a melt index, I₂, of from 1 to 10 grams/10 minutes and a molecular weight distribution Mw/Mn of from 2.0 to 3.0.

The preferred polyethylene compositions for use in this invention are further characterized by A) being unimodal (i.e. having only one peak melting point as determined by differential scanning calorimetry (or “DSC”) and having only one peak in the gel permeation chromatography (or “GPC”) profile; B) having a very narrow molecular weight distribution Mw/Mn of from 2.2 to 2.8 and C) having a density of from 0.925 to 0.950 grams/cubic centimeter. These preferred features are described in further detail below in the section entitled “Resin Architecture”.

The composition of this invention must contain a hindered phenolic antioxidant, preferably in an amount of from 250 to 3500 parts per million by weight (“ppm”). Preferred compositions further contain a phosphite or phosphonite and a hindered amine light stabilizer. Highly preferred compositions also contain carbon black. A description of additives is also provided below.

### Resin Architecture

In general, the term ethylene copolymer (or “interpolymer”), as used herein, is meant to refer to a copolymer of ethylene with at least one alpha olefin monomer containing from 3 to 10 carbon atoms. Thus, ethylene homopolymers are excluded but terpolymers are included. The physical properties of such ethylene copolymers are influenced by their molecular weight, molecular weight distribution, comonomer content and comonomer distribution. It is well known that the use of such comonomers produces copolymers that generally have decreased density and crystallinity as the amount of incorporated comonomer increases.

Conventional (heterogeneous) ethylene copolymers which are prepared with a conventional Ziegler-Natta catalyst generally have a comparatively broad molecular weight distribution (as defined by dividing weight average molecular weight, Mw, by number average molecular weight, Mn—i.e. molecular weight distribution equals Mw/Mn) and a broad comonomer distribution. These resins typically contain at least three distinct polymer fractions, namely a small amount (generally less than 5 weight %) of a low molecular weight, high comonomer content material (also known as “wax”); a significant fraction (15 to 25 weight %) of material having a very high molecular weight and a low comonomer content (also known as “homopolymer”); with the remainder of the copolymer being of intermediate density and molecular weight.

This lack of uniformity with respect to molecular weight and comonomer distribution has several disadvantages for example, the “wax” fraction may limit the use of these interpolymers in applications which come into contact with food and the “homopolymer” fraction is often associated with the poor impact resistance of goods made with these interpolymers. The preferred copolymers are further characterized by having less than 20 weight % of low molecular weight, high comonomer content wax (i.e. for further clarity, less than 2.0 weight % of hexane extractables as determined by the test method established by the United States Food and Drug Administration and published in CFR 177.1520 (c)).

More recently, homogeneous ethylene copolymers have become commercially available. These homogenous polymers have a uniform (or narrow) molecular weight distribution and a uniform comonomer distribution. This, in turn, causes the homogeneous copolymers to have a well-defined melting point (in comparison to some heterogeneous polymers which have a melting point “range”, or even multiple melting points).

The ethylene copolymers used in this invention are homogeneous, as evidenced by having a narrow molecular weight distribution (of from 2.0 to 3.0, preferably from 2.0 to 2.8, most preferably from 2.2 to 2.8).

Molecular weight distribution (defined as weight average molecular weight, Mw, divided by number average molecular weight, Mn, or “Mw/Mn”) is determined by gel permeation chromatography in accordance with ASTM D6474-99, “Standard Test Method for Determining Molecular Weight Distributions and Molecular Weight Averages of Polyolefins by High Temperature Gel Permeation Chromatography”.

As previously noted, the homogeneous copolymers used in this invention preferably have only one melting point as determined by differential scanning calorimetry or “DSC”. The DSC technique is well known to those skilled in the art of polyolefin characterization. It is also well described in the literature, but, to the inventors' best beliefs and knowledge, there is not an ASTM procedure for DSC analysis. However, DSC testing is comparatively simple and generally less time consuming than GPC (and the presence of two DSC peaks is a strong indicator that the Mw/Mn will be greater than 3.0 and/or that the GPC profile may contain more than one peak). Accordingly, DSC might be used to quickly screen for polymers which are likely not suitable for use in this invention.

The polymer compositions used in this invention have a melt index “I₂” (where “I₂” is determined by ASTM D1238 at 190° C. using a 2.16 kg load) of from 1 to 10, preferably from 1 to 8, most preferably from 2 to 6. The density of the preferred polymer compositions is from 0.925 to 0.955 grams per cubic centimeter (“g/cc”), especially from 0.930 to 0.950 g/cc.

The polymer compositions may be prepared by the copolymerization of ethylene with a C₄ to C₁₀ alpha olefin in the presence of a catalyst system which produces homogeneous copolymers. Such catalyst systems are well known to those skilled in the art. Exemplary catalyst systems include the vanadium catalyst disclosed in U.S. Pat. No. 3,645,992 (Elston); metallocene catalysts (as disclosed in U.S. Pat. No. 5,324,800 Welborn et al.); “constrained geometry” catalysts (as described in U.S. Pat. No. 5,064,802, Stevens et al.); and phosphinimine catalysts (as disclosed in U.S. Pat. No. 6,372,864, Brown et al.).

The polyethylene compositions may also contain two or more homogeneous blend components (provided that the resulting blend composition has Mw/Mn of from 2.0 to 3.0 and a melt index, I₂, from 1 to 10).

Such blended compositions may be made using blend components that are prepared as distinct polymers in separate polymerization reactions and then blended together to provide the present compositions. Alternatively, the blend components may be blended using conventional mixing/blending equipment such as a single or twin screw extruder; an internal batch mixer such as a banbury mixer; or a continuous mixer such as a Farrel mixer. The mixing time and temperatures may be readily optimized by those skilled in the art without undue experimentation. As a guideline, mixing temperatures of from 150 to 250° C. are suitable and mixing times of 1-10 minutes may provide satisfactory results. Alternatively (and preferably), the blend components may be prepared in a multiple reactor polymerization system.

Typically, each blend component is a copolymer of ethylene with C₄ₜₒ₈ alpha olefin such as butene-1, pentene-1,4-methyl-1-pentene, hexene-1 or octene-1; with hexene-1 and octene-1 being most preferred.

As previously disclosed, the overall composition of this invention has a narrow molecular weight distribution of less than 3.0. Preferred compositions are prepared with two blend components, each of which represents from 20 to 80 weight % of the total composition. It follows from these preferences that each of the two blend components has a similar molecular weight as well as a narrow molecular weight distribution (i.e. in the sense that the composition would have a molecular weight distribution of greater than 3.0 if the blend components had substantially different molecular weights or if one or both of the blend components had a broad molecular weight distribution).

In addition, it is preferred that each of the blend components has essentially the same density (which, as used herein, means that the difference in density between each of the blend components is less than 0.015 grams per cubic centimeter).

In a preferred embodiment, one blend component has both of a higher molecular weight and a higher comonomer content (lower density) than another blend component. These compositions have excellent environmental stress crack resistance, ESCR. It is particularly preferred to use from 25 to 35 weight % of the high molecular weight, lower density blend component and 65 to 75 weight % of the lower molecular weight blend component.

### Additives

The compositions of this invention must contain a phenolic antioxidant. Suitable examples of phenolic antioxidant are described in sections 1 below (subsection 1.1 to 1.4).

Preferred amounts of phenolic antioxidant are from 250-1500 ppm, especially 250-1000 ppm.

Preferred additive systems further contain a hindered amine light stabilizer (or “HALS”, in section 2.6, below) in an amount of from 500 to 3000 ppm and a phosphite, diphosphite or phosphorite in an amount of from 250 to 2000 ppm (see section 4, below). It is also preferred to include carbon black in an amount of from 1 to 10 weight percent.

The additives may be incorporated into the compositions using mixing equipment such as an extruder, or internal batch mixer (also known as a banbury mixer). The additive may be added “neat” (i.e. directly to the resin); as a “masterbatch” (i.e. by premixing the additives with a small amount of polyethylene which is subsequently mixed with the bulk of the composition); or as “preblends” (i.e. mixtures of the additives). Exemplary additives are set out below.

### 1. Antioxidants

### 1.1 Alkylated Mono-Phenols

For example, 2,6-di-tert-butyl-4-methylphenol; 2-tert-butyl-4,6-dimethylphenol; 2,6-di-tert-butyl-4-ethylphenol; 2,6-di-tert-butyl-4-n-butylphenol; 2,6-di-tert-butyl-4 isobutylphenol; 2,6-dicyclopentyl-4-methylphenol; 2-(.alpha.-methylcyclohexyl)-4,6 dimethylphenol; 2,6-di-octadecyl-4-methylphenol; 2,4,6,-tricyclohexyphenol; and 2,6-di-tert-butyl-4-methoxymethylphenol.

### 1.2 Alkylated Hydroquinones

For example, 2,6di-tert-butyl-4-methoxyphenol; 2,5-di-tert-butylhydroquinone; 2,5-di-tert-amyl-hydroquinone; and 2,6diphenyl-4-octadecyloxyphenol.

### 1.3 Hydroxylated Thiodiphenyl Ethers

For example, 2,2′-thio-bis-(6-tert-butyl-4-methylphenol); 2,2′-thio-bis-(4-octylphenol); 4,4′thio-bis-(6-tertbutyl-3-methylphenol); and 4,4′-thio-bis-(6-tert-butyl-2-methylphenol).

### 1.4 Alkylidene-Bisphenols

For example, 2,2′-methylene-bis-(6-tert-butyl-4-methylphenol); 2,2′-methylene-bis-(6-tert-butyl-4-ethylphenol); 2,2′-methylene-bis-(4-methyl-6-(alpha-methylcyclohexyl)phenol); 2,2′-methylene-bis-(4-methyl-6-cyclohexylphenol); 2,2′-methylene-bis-(6-nonyl-4-methylphenol); 2,2′-methylene-bis-(6-nonyl-4methylphenol); 2,2′-methylene-bis-(6-(alpha-methylbenzyl)-4-nonylphenol); 2,2′-methylene-bis-(6-(alpha, alpha-dimethylbenzyl)-4-nonyl-phenol); 2,2′-methylene-bis-(4,6-di-tert-butylphenol); 2,2′-ethylidene-bis-(6-tert-butyl-4-isobutylphenol); 4,4′methylene-bis-(2,6-di-tert-butylphenol); 4,4′-methylene-bis-(6-tert-butyl-2-methylphenol); 1,1-bis-(5-tert-butyl-4-hydroxy-2-methylphenol)butane 2,6-di-(3-tert-butyl-5-methyl-2-hydroxybenzyl)-4-methylphenol; 1,1,3-tris-(5-tert-butyl-4-hydroxy-2-methylphenyl)butane; 1,1-bis-(5-tert-butyl-4-hydroxy2-methylphenyl)-3-dodecyl-mercaptobutane; ethyleneglycol-bis-(3,3,-bis-(3′-tert-butyl-4′-hydroxyphenyl)-butyrate)-di-(3-tert-butyl-4-hydroxy-5-methylphenyl)-dicyclopentadiene; di-(2-(3′-tert-butyl-2′hydroxy-5′methylbenzyl)-6-tert-butyl-4-methylphenyl)terephthalate; and other phenolics such as monoacrylate esters of bisphenols such as ethylidene bis-2,4-di-t-butylphenol monoacrylate ester.

### 2. UV Absorbers and Light Stabilizers

2.1 2-(2′-hydroxyphenyl)-benzotriazoles

For example, the 5′-methyl-,3′5′-di-tert-butyl-,5′-tert-butyl-,5′(1,1,3,3-tetramethylbutyl)-,5-chloro-3′,5′-di-tert-butyl-,5-chloro-3′-tert-butyl-5′-methyl-3′-sec-butyl-5′-tert-butyl-,4′-octoxy,3′,5′-ditert-amyl-3′,5′-bis-(alpha, alpha-di methylbenzyl)-derivatives.

### 2.2 2-Hydroxy-Benzophenones

For example, the 4-hydroxy-4-methoxy-,4-octoxy,4-decyloxy-, 4-dodecyloxy-,4-benzyloxy,4,2′,4′-trihydroxy- and 2′-hydroxy-4,4′-dimethoxy derivative.

### 2.3 Esters of Substituted and Unsubstituted Benzoic Acids

For example, phenyl salicylate; 4-tertbutylphenyl-salicylate; octylphenyl salicylate; dibenzoylresorcinol; bis-(4-tert-butylbenzoyl)-resorcinol; benzoylresorcinol; 2,4-d i-tert-butyl-phenyl-3,5-d i-tert-butyl-4-hydroxybenzoate; and hexadecyl-3,5-d i-tert-butyl-4-hydroxybenzoate.

### 2.4 Acrylates

For example, alpha-cyano-.beta,.beta.-diphenylacrylic acid-ethyl ester or isooctyl ester; alpha-carbomethoxy-cinnarnic acid methyl ester; alpha-cyano-.beta.-methyl-p-methoxy-cinnamic acid methyl ester or butyl ester; alpha-carbomethoxy-p-methoxy-cinnamic acid methyl ester; and N-(beta-carbomethoxy-beta-cyano-vinyl)-2-methyl-indoline.

### 2.5 Nickel Compounds

For example, nickel complexes of 2,2′-thio-bis(4-(1,1,1,3-tetramethylbutyl)-phenol), such as the 1:1 or 1:2 complex, optionally with additional ligands such as n-butylamine, triethanolamine or N-cyclohexyl-diethanolamine; nickel dibutyldithiocarbamate; nickel salts of 4-hydroxy-3,5-di-tert-butylbenzylphosphonic acid monoalkyl esters, such as of the methyl, ethyl, or butyl ester; nickel complexes of ketoximes such as of 2-hydroxy-4-methyl-phenyl undecyl ketoxime; and nickel complexes of 1-phenyl-4-lauroyl-5-hydroxy-pyrazole, optionally with additional ligands.

### 2.6 Sterically Hindered Amines or HALS

For example, bis(2,2,6,6-tetramethylpiperidyl)-sebacate; bis-5(1,2,2,6,6-pentamethylpiperidyl)-sebacate; n-butyl-3,5-di-tert-butyl-4-hydroxybenzyl malonic acid bis(1,2,2,6,6,-pentamethylpiperidyl)ester; condensation product of 1-hydroxyethyl-2,2,6,6-tetramethyl-4-hydroxy-piperidine and succinic acid; condensation product of N,N′-(2,2,6,6-tetramethylpiperidyl)-hexamethylenediamine and 4-tert-octylamino-2,6-dichloro-1,3,5-s-triazine; tris-(2,2,6,6-tetramethylpiperidyl)-nitrilotriacetate, tetrakis-(2,2,6,6-tetramethyl-4-piperidyl)-1,2,3,4butane-tetra-arbonic acid; and 1,1′(1,2-ethanediyl)-bis-(3,3,5,5-tetramethylpiperazinone). These amines typically called HALS (Hindered Amines Light Stabilizing) include butane tetracarboxylic acid 2,2,6,6-tetramethyl piperidinol esters. Such amines include hydroxylamines derived from hindered amines, such as di(1-hydroxy-2,2,6,6-tetramethylpiperidin-4-yl) sebacate; 1-hydroxy 2,2,6,6-tetramethyl-4-benzoxypiperidine; 1-hydroxy-2,2,6,6-tetramethyl-4-(3,5-di-tert-butyl-4-hydroxy hydrocinnamoyloxy)-piperdine; and N-(1-hydroxy-2,2,6,6-tetramethyl-piperidin-4-yl)-epsiloncaprolactam.

### 2.7 Oxalic Acid Diamides

For example, 4,4′-di-octyloxy-oxanilide; 2,2′-di-octyloxy-5′,5′-ditert-butyloxanilide; 2,2′-di-dodecyloxy-5′,5′di-tert-butyl-oxanilide; 2-ethoxy-2′-ethyl-oxanilide; N,N′-bis(3-dimethylaminopropyl)-oxalamide; 2-ethoxy-5-tert-butyl-2′-ethyloxanilide and its mixture with 2-ethoxy-2′-ethyl-5,4-di-tert-butyloxanilide; and mixtures of ortho- and para-methoxy as well as of o- and p-ethoxy-disubstituted oxanilides.

### 2.8 Hydroxyphenyl-s-triazines

For example, 2,6-bis-(2,4-dimethylphenyl)-4-(2-hydroxy-4octyloxyphenyl)-s-triazine; 2,6-bis(2,4-dimethylphenyl)-4-(2,4-dihydroxyphenyl)-s-triazine; 5 2,4-bis(2,4-dihydroxyphenyl)-6-(4-chlorophenyl)-s-triazine; 2,4-bis(2-hydroxy-4-(2-hydroxyethoxy)phenyl)-6-(4-chlorophenyl)-s-triazine; 2,4-bis(2hydroxy-4-(2-hydroxyethoxy)phenyl)-6-phenyl-s-triazine; 2,4-bis(2-hydroxy-4-(2-hydroxyethoxy)-phenyl)-6-(2,4-dimethylphenyl)-s-tri azine; 2,4-bis(2-hydroxy-4-(2-hydroxyethoxy)phenyl)-6-(4-bromo-phenyl)-s-triazine; 2,4-bis(2-hydroxy-4-(2-acetoryethoxy)phenyl)-6-(4-chlorophenyl)-s-triazine; and 2,4-bis(2,4-dihydroxyphenyl)-6-(2,4-dimethylphenyl)-1-s-triazine.

### 3. Metal Deactivators

For example, N,N′diphenyloxalic acid diamide; N-salicylal-N′-salicyloylhydrazine; N,N′-bis-salicyloylhydrazine; N,N′-bis-(3,5-di-tert-butyl-4-hydrophenylpropionyl)-2-hydrazine; salicyloylamino-1,2,4-triazole; and bis-benzylidene-oxalic acid dihydrazide.

### 4. Phosphites and Phosphonites

For example, triphenyl phosphite; diphenylalkyl phosphates; phenyldialkyl phosphates; tris(nonyl-phenyl)phosphite; trilauryl phosphite; trioctadecyl phosphite; distearyl pentaerythritol diphosphite; tris(2,4-di-tert-butylphenyl)phosphite; diisodecyl pentaerythritol diphosphite; 2,4,6-tri-tert-butylphenyl-2-butyl-2-ethyl-1,3-propanediol phosphite; bis(2,4-di-tert-butylphenyl)pentaerythritol diphosphite tristearyl sorbitol triphosphite; and tetrakis(2,4-di-tert-butylphenyl)4,4′-biphenylene diphosphonite.

It is particularly preferred to include a phosphite and a diphosphite.

### 5. Peroxide Scavengers

For example, esters of betathiodipropionic acid, for example the lauryl, stearyl, myristyl or tridecyl esters; mercaptobenzimidazole or the zinc salt of 2-mercaptobenzimidazole; zinc-dibutyldithiocarbamate; dioctadecyldisulfide; and pentaerythritottetrakis-(beta-dodecylmercapto)-propionate.

### 6. Hydroxylamines and Amine Oxides

For example, N,N-dibenzylhydroxylamine; N,N-diethylhydroxylamine; N,N-dioctylhydroxylamine; N,N-dilaurylhydroxylamine; N,N-ditetradecylhydroxylamine; N,N-dihexadecylhydroxylamine; N,N-dioctadecylhydroxylamine; N-hexadecyl-N-octadecylhydroxylamine; N-heptadecyl-N-octadecylhydroxylamine; and N,N-dialkylhydroxylamine derived from hydrogenated tallow amine. The analogous amine oxides (as disclosed in U.S. Pat. No. 5,844,029, Prachu et al.) are also suitable.

### 7. Nitrones

For example, N-benzyl-alpha-phenyl nitrone; N-ethyl-alpha-methyl nitrone; N-octyl-alpha-heptyl nitrone; N-lauryl-alpha-undecyl nitrone; N-tetradecyl-alpha-tridecyl nitrone; N-hexadecyl-alpha-pentadecyl nitrone; N-octadecyl-alpha-heptadecylnitrone; N-hexadecyl-alpha-heptadecyl nitrone; N-octadecyl-alpha-pentadecyl nitrone; N-heptadecyl-alpha-heptadecyl nitrone; N-octadecyl-alpha-hexadecyl nitrone; and nitrone derived from N,N-dialkylhydroxylamine derived from hydrogenated tallow amine.

### 8. Polyamide Stabilizers

For example, copper salts in combination with iodides and/or phosphorus compounds and salts of divalent manganese.

### 9. Basic Co-Stabilizers

For example, melamine; polyvinylpyrrolidone; dicyandiamide; triallyl cyanurate; urea derivatives; hydrazine derivatives; amines; polyamides; polyurethanes; alkali metal salts and alkaline earth metal salts of higher fatty acids, for example, Ca stearate, calcium stearoyl lactate, calcium lactate, Zn stearate, Mg stearate, Na ricinoleate and K palmitate; antimony pyrocatecholate or zinc pyrocatecholate, including neutralizers such as hydrotalcites and synthetic hydrotalcites; and Li, Na, Mg, Ca, Al hydroxy carbonates.

### 10. Nucleating Agents

For example, 4-tert-butylbenzoic acid; adipic acid; diphenylacetic acid; sodium salt of methylene bis-2,4-dibutylphenyl; cyclic phosphate esters; sorbitol tris-benzaldehyde acetal; and sodium salt of bis(2,4-di-t-butylphenyl) phosphate or Na salt of ethylidene bis(2,4-di-t-butyl phenyl)phosphate. Nucleating agents may improve stiffness of the rotomolded part.

### 11. Fillers and Reinforcing Agents

For example, calcium carbonate; silicates; glass fibers; asbestos; talc; kaolin; mica; barium sulfate; metal oxides and hydroxides; carbon black and graphite. Carbon black is especially preferred.

### 12. Other Additives

For example, plasticizers; epoxidized vegetable oils, such as epoxidized soybean oils; lubricants; emulsifiers; pigments; flame proofing agents; anti-static agents; and thiosynergists, such as dilaurythiodipropionate or distearylthiodipropionate.

Further details are provided in the following non-limiting examples.

### EXAMPLES

The following polyethylene resin compositions were used in these examples.

Resin R1: a linear, thermoplastic ethylene-octene copolymer having a melt index, I₂, of about 2 as determined by ASTM D1238 (190° C., 2.16 kg load) and a density of about 0.944 grams/cubic centimeter (“g/cc”). R1 is further characterized by having a molecular weight distribution, Mw/Mn, of about 2.3. The polymer was prepared in a dual reactor polymerization process using a single site catalyst.

Resin R2: a linear, thermoplastic ethylene-octene copolymer having a melt index, I₂, of about 5 as determined by ASTM D1238 (190° C., 2.16 kg load) and a density of about 0.939 g/cc. R2 has a molecular weight distribution, Mw/Mn, of about 2.3. The polymer was prepared in a dual reactor polymerization process using a single site catalyst. The DSC melting point thermogram showed a narrow sharp peak at about 126° C.

### Example 1—Comparative

Resins R1 and R2 were formulated with an additive package, which provides excellent results when used to prepare rotation molded parts, as follows (with all ingredients shown as “aiming points”):

Additive Package

| Ingredient | Amount (parts per million) |
|---|---|
| HA | 500 |
| P1 | 800 |
| P2 | 500 |
| HALS1 | 500 |
| HALS2 | 2000 |

Definitions
HA: hydroxyl amine (reported to be prepared by the oxidation of a primary amine having two hydrogenated tallow groups bonded to nitrogen).
P1: phosphite sold under trademark Irgaphos 168 by Ciba.
P2: diphosphite sold under the trademark Doverphos 9228 by Dow Chemicals.
HALS1: hindered amine light stabilizer sold under the trademark Tinvin 622 by Ciba.
HALS2: hindered amine light stabilizer sold under the trademark Chimassorb 944.

Oxidative induction time experiments (ASTM D3895) were completed at 220° C. in quadruplicate. Results are provided in Table 1 with OIT values for the four experiments (OIT1-OIT4) expressed in minutes.

TABLE 1

| Resin | OIT1 | OIT2 | OIT3 | OIT4 | Average |
|---|---|---|---|---|---|
| R1 | 2.95 | 1.88 | 2.90 | 2.56 | 2.57 |
| R2 | 3.65 | 2.20 | 2.46 | 2.77 | 2.77 |

### Example 2—Inventive

Resins R1 and R2 (containing the additive package described above) were then compounded with a phenolic antioxidant (sold under the trademark Irganox 1010 by Ciba) in an amount shown in Table 2. The compounded formulations were prepared in a Brabender™ mixer (having a mixing bowl and roller blades) at 160° C., under a nitrogen blanket. The mixing rolls operated at 60 revolutions per minute. OIT values were again determined in quadruplicate, with results shown in Table 2.

TABLE 2

| Additional | | | | | | |
|---|---|---|---|---|---|---|
| hindered | | | | | | |
| phenolic | | | | | | |
| (Irganox 1010) | Resin | OIT1 | OIT2 | OIT3 | OIT4 | Average |
| 1500 ppm | R1 | 9.7 | 8.4 | 8.6 | 8.0 | 8.7 |
| 1500 ppm | R2 | 6.8 | 7.4 | 6.3 | 6.2 | 6.7 |

### Thus, the addition of hindered phenolic antioxidant improved the OIT values.

### Example 3—Inventive

Resin R2 was initially prepared with only 300 ppm of P1. The resins were then compounded (as described above) with an additive package consisting of HA, P1, P2, HALS1 and HALS2 (each in the amounts used in comparative Example 1) and an additional 1500 ppm of Irganox 1010 (formulation 3.1) or 2000 ppm of Irganox 1010 (formulation 3.2). OIT values are shown in Table 3.

TABLE 3

| Formulation | OIT1 | OIT2 | OIT3 | OIT4 | Average |
|---|---|---|---|---|---|
| 3.1 | 16.5 | 15.3 | 14.1 | 17.0 | 15.7 |
| 3.2 | 27.4 | 20.5 | 26.0 | 25.9 | 25.0 |

A review of the results in Tables 2 and 3 shows that the mode of addition of the additives can impact the OIT values. It is preferred to add the phenolic antioxidant at the same time as the other additives.

### Example 4

Resins R1 and R2 (containing the base additive packages described in Example 1) were blended together in a weight ratio of about ½, together with i) a carbon black in polyethylene masterbatch (about 5% by weight of a masterbatch containing about 45 weight % carbon black to provide about 2.5 weight % carbon black in the composition); and ii) 1500 ppm of Irganox 1010 hindered phenolic.

The resulting blend had an OIT value of 25.2 minutes (as determined by ASTM D3895, average of 4 values).

What is claimed is:

1. A pipe coating resin composition having an oxidative induction time in excess of five minutes, wherein, said composition comprises:
i) a thermoplastic ethylene-alpha olefin copolymer composition having a melt index, I₂, as determined by ASTM D1238 of from 1 to 10 grams/10 minutes and a molecular weight distribution of from 2.0 to 3.0; and
ii) an antioxidant system comprising from 250 to 2500 ppm of a hindered phenolic, a secondary antioxidant which is a phosphorus (III) compound and a hindered amine light stabilizer.

2. The composition of claim 1 wherein said secondary antioxidant is a phosphite.

3. The composition of claim 2, which further comprises carbon black.

4. The composition of claim 2 wherein said phosphite is present in an amount of from 200 to 2000 ppm and said hindered amine light stabilizer is present in an amount of from 500 to 3000 ppm.

5. The composition of claim 2 wherein said carbon black is present in an amount of from 1 to 3 weight percent.

6. A process for coating a pipe, said process comprising the application to said pipe of a pipe coating resin composition having an oxidative induction time in excess of five minutes, wherein, said composition comprises:
i) a thermoplastic ethylene-alpha olefin copolymer composition having a melt index, I₂, as determined by ASTM D1238 of from 1 to 10 grams/10 minutes and a molecular weight distribution of from 2.0 to 3.0; and
ii) an antioxidant system comprising from 250 to 2500 ppm of a hindered phenolic, a secondary antioxidant which is a phosphorus (III) compound and a hindered amine light stabilizer.
